(19) United States
(12) Patent Application Publication
(10) Pub. No.: US 2025/0340093 A1
(43) Pub. Date: Nov. 6, 2025

(54) DUAL TRAILING LINK REAR SUSPENSION APPARATUS, SYSTEM, AND METHOD USEFUL FOR AERODYNAMIC ENCLOSURE

(71) Applicant: APTERA MOTORS CORP., Carlsbad, CA (US)

(72) Inventor: Shrikant CHOPADE, San Diego, CA (US)

(21) Appl. No.: 19/267,486

(22) Filed: Jul. 11, 2025

Related U.S. Application Data
(63) Continuation-in-part of application No. 17/901,374, filed on Sep. 1, 2022, now Pat. No. 12,377,693.

(51) Int. Cl. B60G 3/20; B60G 7/00

(52) U.S. Cl. CPC B60G 3/207; B60G 7/006; B60G 2200/13; B60G 2202/312

(57) ABSTRACT

A dual trailing link, rear wheel suspension system useful for an aerodynamic enclosure is described. The trailing links may have proximal ends coupled to a rear subframe and distal ends coupled to a bracket with a knuckle for coupling to a wheel. The distal ends may have a larger distance between them than the proximal ends, allowing for an improved instantaneous center, which may be useful for determining lift/squat characteristics. The distal ends may be disposed in line with the wheel axis of rotation, thereby providing the largest possible effective swingarm length, for a predetermined chassis-wheel distance, which provides a smoother, more comfortable riding experience. The suspension system may advantageously fit at least partially within an aerodynamic enclosure, thereby reducing the drag contribution when the vehicle moves through a flow field. The present invention therefore maximizes swing arm length via a virtual pivot point, while minimizing both space and drag.

### CROSS-REFERENCE TO RELATED APPLICATION

This application is a continuation-in-part of, and claims the benefit of and priority to, co-pending U.S. patent application Ser. No. 17/901,374, filed on Sep. 1, 2022, entitled “Rear Suspension For Vehicle Having Improved Swing Arm”, which is incorporated by reference herein in its entirety.

### TECHNICAL FIELD

The present invention relates generally to a suspension system for a vehicle and, more particularly, to a rear suspension having improved geometric characteristics that provide for an effective swingarm length having an instantaneous center that extends beyond the confines of the enclosure, for example, adapted to fit within an aerodynamic enclosure, such as a body panel, of an electric vehicle, thereby providing improved lift and squat characteristics of the vehicle.

### BACKGROUND

A conventional suspension for a vehicle connects a wheel axle to a vehicle body and controls the position of a wheel with respect to the vehicle body during operation of the vehicle as shown in FIGS. 1A-1B, and dynamic operational aspects in FIGS. 5B, 6B, and 7B. More specifically, a conventional rear suspension having a trailing arm is illustrated in FIG. 1A, in which a tire/wheel 706 is mounted on an axle 707 that is transversely arranged with respect to the vehicle body, a swingarm 721 is connected to the axle 707 at a first pivot point 723 and to the vehicle body at a second pivot point 722, and a spring/damper assembly 740 that is disposed between the swingarm 721 and the vehicle body 210. Optimal handling, comfort and safety may be obtained when the tire 706 is prevented from directly transmitting an impact or vibration from a road surface to the vehicle body 210.

The length of the swingarm 721 and its vehicle body side pivot point 722 determine the transfer characteristics of a wheel impulse to the vehicle body 210. For example, a short swingarm will provide a small radius of rotation 708a for the wheel as it deflects from its normal position, which for large rotation angles, will cause some of the wheel 706 momentum to be transferred to the vehicle body 210 in a forward/reverse direction, while the remainder is transferred through the biasing 741 and mass damper 742 elements in a vertical direction. A sudden, forward/reverse motion of the vehicle is experienced by the occupants as a jolting of the vehicle. Even small amounts can lead to passenger discomfort. A long swingarm 721, on the other hand, provides a larger radius of rotation 708a, thereby reducing the angle of the swingarm 721 corresponding to an equivalent vertical wheel 706 displacement. The smaller displacement angle reduces the forward/reverse component of the wheel motion while retaining the vertical component. This arrangement provides a smoother, more comfortable passenger experience.

In another aspect of the system behavior, the wheel reacts torque about the axle 707 as a force along the line 751a between the tire contact patch 709 and the swingarm pivot point 750, such as illustrated in FIG. 1A. The effect of this force on the motion of the vehicle depends on the relationship of this vector 751a to the vehicle center of gravity, CG. For example, if the vector 751a passes through a point located above the CG, an accelerating torque on the wheel 706 (counterclockwise (CCW) motion in FIG. 1A) will create a CCW rotational force about the CG and cause the rear of the vehicle to lift. Conversely, if the vector 751a passes through a point located below the CG, an accelerating torque on the wheel (CCW motion) will create a clockwise (CW) rotational force about the CG and cause the rear to squat. In this way the acceleration/deceleration characteristics of the vehicle (lift/squat) may be determined by appropriate placement of the instantaneous center (IC) 750 of the rear suspension.

In other conventional designs, as represented in FIG. 1B, dual trailing links 731, 734 with distal ends 733, 736 attached to a bracket 737 including a knuckle 738 for the wheel axle 707 may be used in place of a swingarm to provide an IC for the suspension that is forward of the (proximal) linkage points 732, 735 with the vehicle body 230, thereby reducing the angle of the reaction vector 751b with respect to the road. Thus, the moment arm formed by the reaction vector 751a-b and the CG may be moved from above the CG (creating lift) to below the CG (creating squat). A required geometric condition for this arrangement is that the distance between the distal linkage points 733, 736 must be greater than the distance between the proximal linkage points 731, 734 such that lines extrapolated through the trailing links intersect at a point 750 more toward the front of the vehicle. As the distal ends of the linkage arms 733, 736 move up and down the IC 750 moves in seesaw (counteracting) fashion about a virtual fulcrum 724 on a line between the knuckle 738 and IC 750. The distance from the fulcrum 724 to the knuckle acts as an effective swingarm length 753. From FIGS. 1A and B it is evident that the rear axis locus of motion 708b with the effective swingarm has a smaller radius of curvature than the rear axis locus of motion 708a with the single beam swingarm 721. The effect of using short trailing links 731, 734 and a bracket 728, then, is to reduce the effective swingarm length 753.

In conjunction with the above, one problem associated with conventional suspension systems relates to the concept that a longer swing arm generally exhibits better ride characteristics as compared to that of a shorter swing arm. However, the swing arm length may be limited by other components of the vehicle and the free physical space available and/or enclosure of the wheel. For example, swing arm length may be limited owing to the location of the chassis, which in turn must maintain structural integrity and placement of members thereof.

In another problem associated with conventional suspension systems, particularly when the vehicle moves through a flow field, suspension components function as a protuberances extending outwardly from the vehicle body that tend to trip the flow, thereby inducing flow separation and resulting in increased drag.

Accordingly, what is needed is a rear wheel suspension system with dual trailing links and improved effective swingarm length in a compact form, capable of fitting within an aerodynamic enclosure. The present invention provides such a rear wheel suspension system.

### SUMMARY

It is an object of the present invention to provide a suspension apparatus, system, and method comprising an optimally-lengthened swing arm. The suspension components described herein are without limitation via embodiments of a rear wheel system useful for fitting within the physical confines of an aerodynamic enclosure. The rear wheel suspension system may be suitable for two-, three-, or four-wheeled vehicles, and other suspension applications, such as any vehicle having a wheel.

It is also an object of the present invention to provide a kinematic model for illustrating further the invention representing a plurality of pivotable or rotatable linkages that produce an effective swing arm of optimal length and/or optimal lift/squat characteristics, where the specific geometry of the linkages is non-limiting thereto.

It is also an object of the present invention to provide an apparatus, system, and method for a rear wheel suspension system with dual trailing links and improved effective swingarm length in a compact form, capable of fitting within an aerodynamic enclosure.

It is also an object of the present invention to provide an apparatus, system, and method for a rear wheel suspension system wherein the swing arm length is adapted to provide optimum passenger comfort, such as, for example, via lift and squat characteristics, and/or minimizing the effect of impulses and vibrations transmitted through the tire from the road or driving surface.

It is also an object of the present invention to provide a rear-wheel enclosure for a swingarm suspension configured to exhibit low drag characteristics when subject to a flow field, thereby reducing the rear-wheel enclosure's contribution to the overall vehicle drag coefficient. The enclosure may take any suitable design, form or shape, such as that of a zero-cambered air foil. The suspension may be adapted to fit at least partially, but ideally entirely, within the restricted volume of the aerodynamic enclosure and at the same time provide an increased effective swingarm length for more vertical shock absorption while dual trailing links establish an instantaneous center with beneficial lift and squat characteristics.

It is also an object of the present invention to provide a suspension system having improved ease of manufacturing, while maintaining strength, durability, and other characteristics.

Other desirable features and characteristics will become apparent from the subsequent detailed description, the drawings, and the appended claims, when considered in view of this Summary.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1A illustrates a schematic diagram of rear suspension system with a single trailing link, according to the prior art;

FIG. 1B illustrates a schematic diagram of rear suspension system with dual trailing links and an extending bracket, according to the prior art;

FIG. 2A illustrates a back, top, right perspective view of a dual trailing link rear suspension within an aerodynamic cowling, according to an embodiment of the present invention;

FIG. 2B illustrates a front, bottom, right perspective view of a dual trailing link rear suspension within an aerodynamic cowling, according to an embodiment of the present invention;

FIG. 3A illustrates a top view of the dual trailing links and upright bracket, according to an embodiment of the present invention;

FIG. 3B illustrates an exploded perspective view of the dual trailing links and upright bracket, according to an embodiment of the present invention;

FIG. 3C illustrates another exploded perspective view of the dual trailing links and upright bracket, according to an embodiment of the present invention;

FIG. 3D illustrates a left-side view of the dual trailing links and upright bracket, according to an embodiment of the present invention;

FIG. 4 illustrates a right-side view of the rear subframe, rear suspension and aerodynamic cowling, according to an embodiment of the present invention;

FIG. 5A illustrates a right-side view of the rear suspension system with a panel of the aerodynamic cowling removed for visibility and the rear suspension in a maximum upward displacement state, according to an embodiment of the present invention;

FIG. 5B illustrates a right-side view of the rear suspension system with a panel of the aerodynamic cowling removed for visibility and the rear suspension in a neutral state, according to an embodiment of the present invention;

FIG. 5C illustrates a right-side view of the rear suspension system with a panel of the aerodynamic cowling removed for visibility and the rear suspension in a maximum downward displacement state, according to an embodiment of the present invention;

FIG. 6A illustrates a schematic diagram of the geometry of a rear suspension system in a maximum upward displacement state of the embodiment shown in FIG. 5A, and according to an embodiment of the present invention;

FIG. 6B illustrates a schematic diagram of the geometry of a rear suspension system in a maximum upward displacement state, according to the prior art;

FIG. 7A illustrates a schematic diagram of the geometry of a rear suspension system in a neutral state, of the embodiment shown in FIG. 5B, and according to an embodiment of the present invention;

FIG. 7B illustrates a schematic diagram of the geometry of a rear suspension system in a neutral state, according to the prior art;

FIG. 8A illustrates a schematic diagram of the geometry of a rear suspension system in a maximum downward displacement state, of the embodiment shown in FIG. 5C, and according to an embodiment of the present invention;

FIG. 8B illustrates a schematic diagram of the geometry of a rear suspension system in a maximum downward displacement state, according to the prior art;

FIG. 9 illustrates a right-side view of an aerodynamic vehicle including an aerodynamic cowling, according to another embodiment of the present invention;

FIG. 10 illustrates a bottom view of an aerodynamic vehicle including an aerodynamic cowling further illustrating the invention; and

FIG. 11 illustrates a front, bottom, right-side perspective view of an aerodynamic vehicle including an aerodynamic cowling according to the invention thereof.

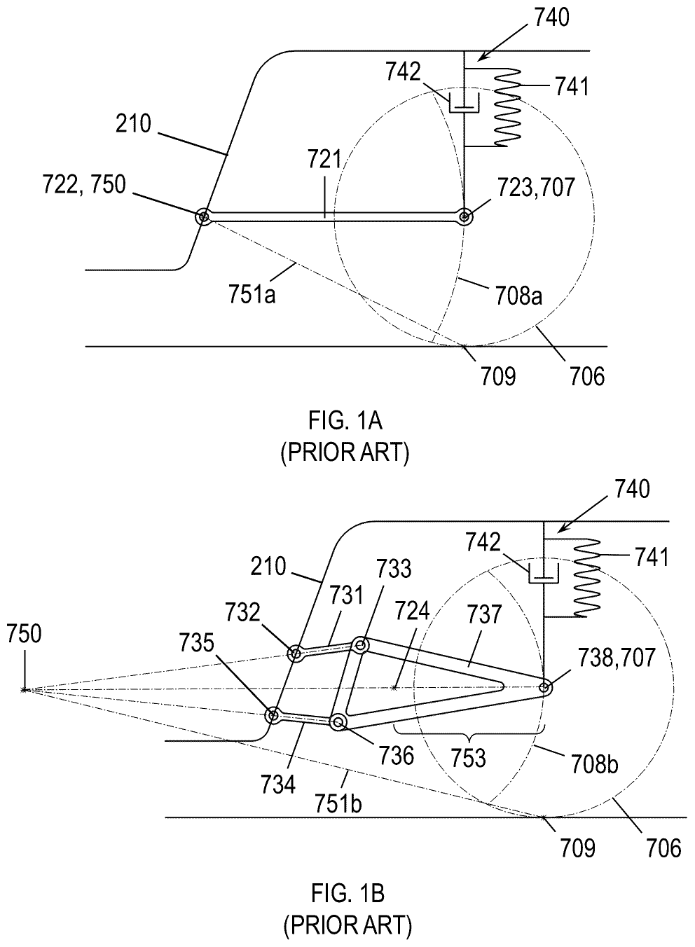

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The term “enclosure” as used herein includes any structure within which a suspension system may be at least partially disposed. In preferred embodiments, the suspension system may be almost entirely, or entirely, disposed within the enclosure, where only a portion of the vehicle tire is exposed to the flow field. This may result in the direct drag contribution from the suspension system components to the overall drag coefficient being substantially reduced, such that the enclosure instead contributes to the drag coefficient. In this way, the enclosure may be formed of an aerodynamic shape to thereby minimize the drag contribution of the suspension system. An enclosure as contemplated herein may take any form. In certain embodiments, the enclosure may be a zero-cambered airfoil shape, such as known NACA airfoil shapes and/or three-dimensional wing shapes. In the embodiments contemplated herein, an enclosure may be, or include, a body panel of the vehicle. The term “enclosure” shall be construed as non-limiting, and may refer, for example, to any structure that inhibits the actual (but not necessarily the virtual) swing arm length. Terms similar to “enclosure” may include “housing”, “cowling”, “frame”, “jacket”, “shell”, “sleeve”, “pant”, “skirt”, and the like.

The drawings featured in the figures are provided for the purposes of illustrating some embodiments of the present invention and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

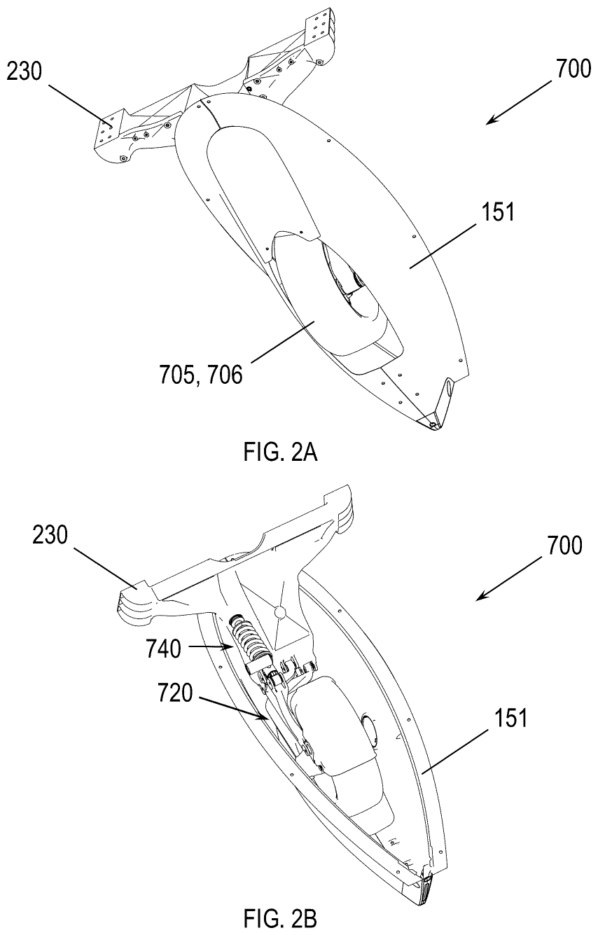

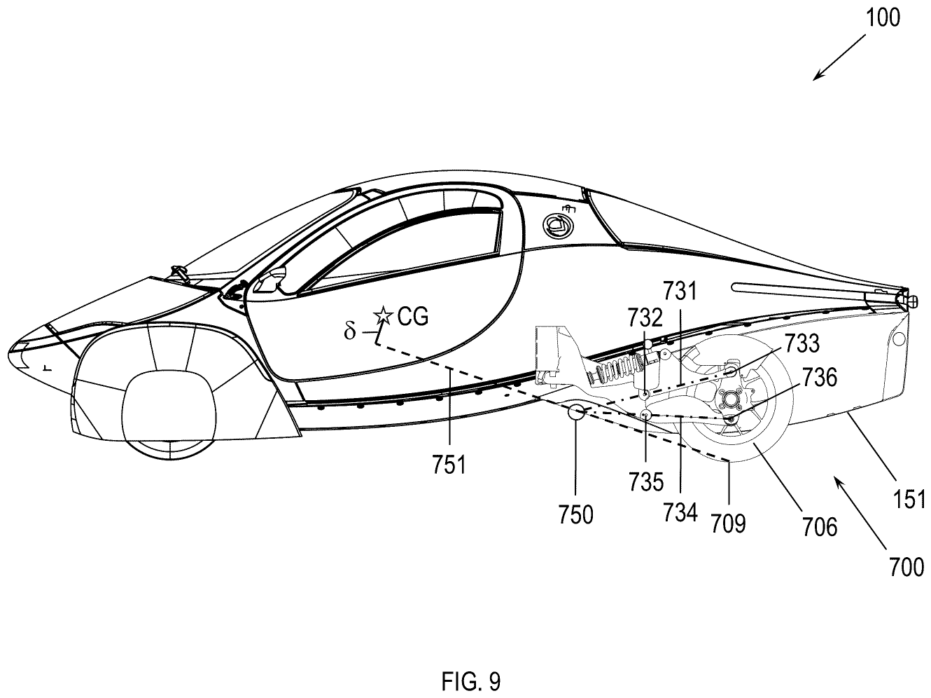

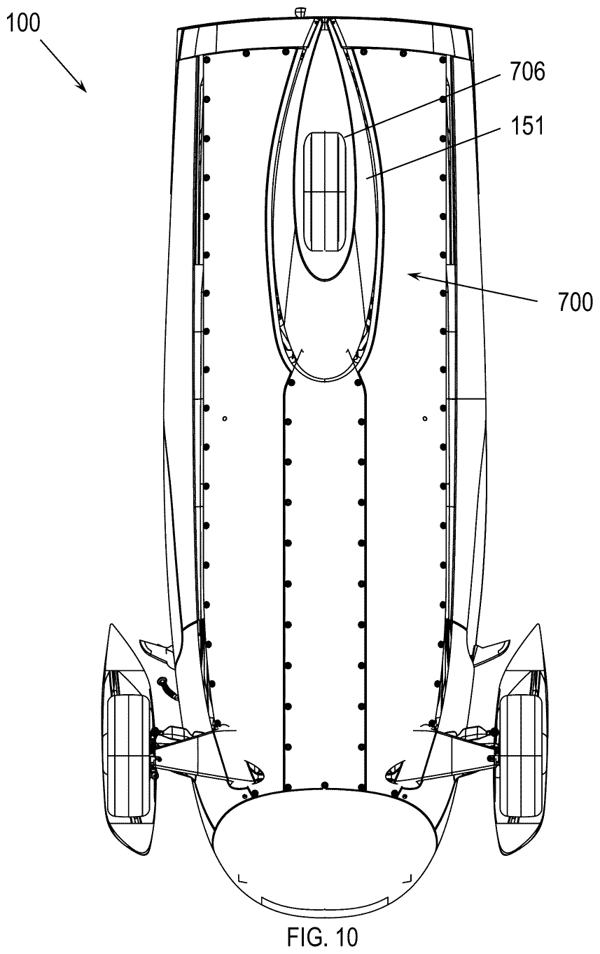

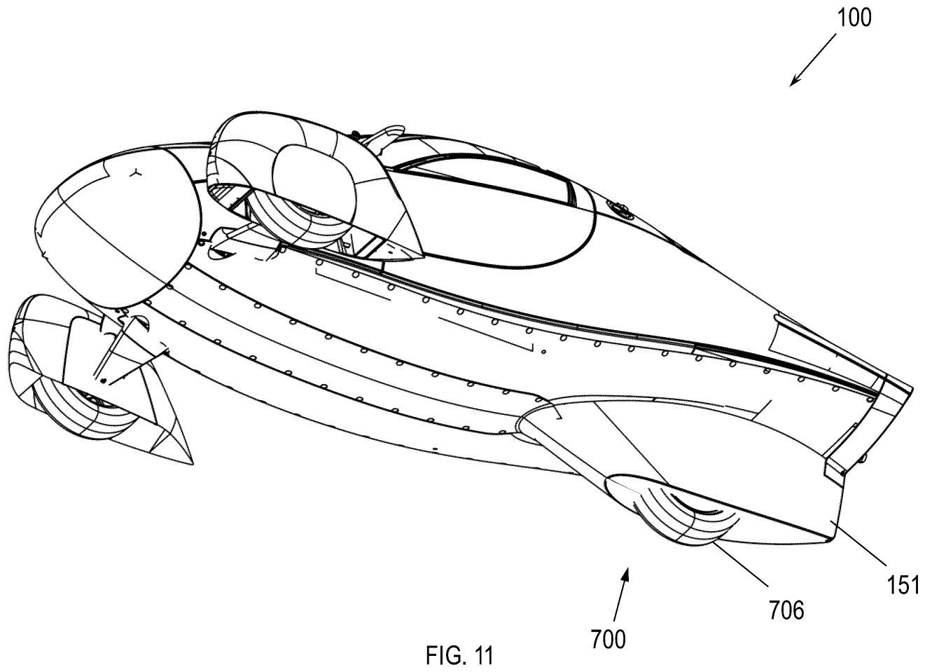

As illustrated in FIGS. 2A-5C, an aerodynamic vehicle suspension apparatus, system, and method according to the present invention is generally shown as element 700. The suspension system 700 may include an enclosure 151 that at least partially surrounds a suspension assembly 720, the suspension assembly 720 being coupled to a vehicle chassis, such as a rear subframe 230. As displayed in FIGS. 2A and 2B, a rear suspension assembly 720 may be for a three-wheeled vehicle 100 such as shown in FIGS. 9-11. The rear suspension assembly 720 may be further connected to a wheel 705 and tire 706 assembly. The rear suspension may comprise dual trailing links 731, 734 connected to a rear upright bracket, referred to as an upright 737 herein. The upper trailing link 731 may further be connected to a spring/damper assembly 740. Importantly, there is a reduction of parts to, and/or improved manufacturability of, the suspension assembly 720 that may primarily comprise the upper trailing link 731, the lower trailing link 734, each being coupled to a subframe 230, and also the upright 737—these four components, for a given selection of respective loci of pivot points, can dictate the kinematics of the suspension system 700. The spring/damper assembly 740 may therefore be disposed in any advantageous position, such as a position suitable for counteracting external excitations and/or physical space limitations. In preferred embodiments, the suspension system 700 may exhibit a small cross section with respect to the direction of motion of the vehicle, thereby minimizing aerodynamic drag. Accordingly, the width of the enclosure 151 may be as narrow as possible to enclose, or substantially enclose, the suspension assembly 720. The rear subframe 230 and suspension assembly 720 are generally adapted to fit within the enclosure 151, while advantageously allowing vertical travel of the wheel 705 and tire 706 to absorb vibrations and impulses imparted on the system 700 from the road or traveled surface.

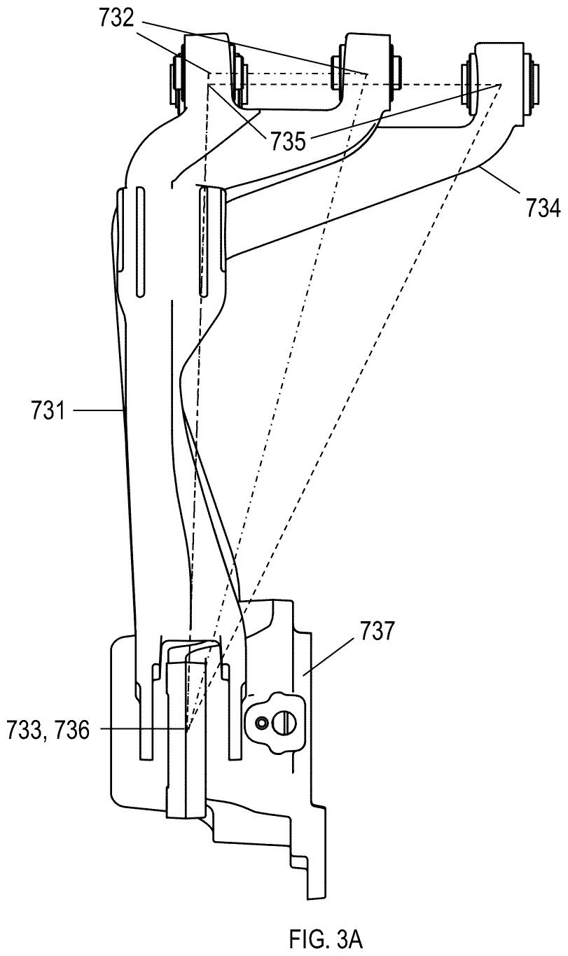

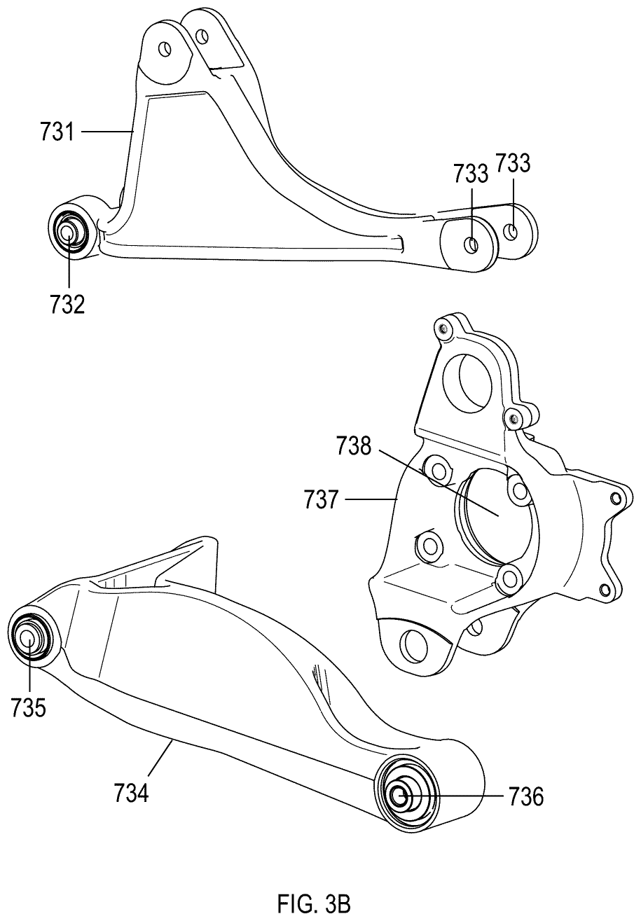

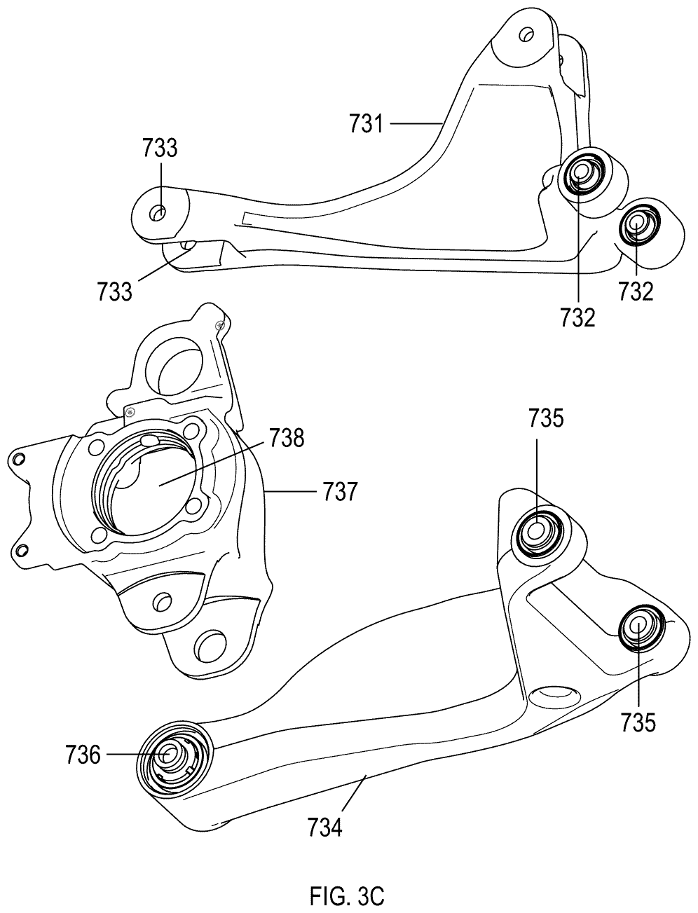

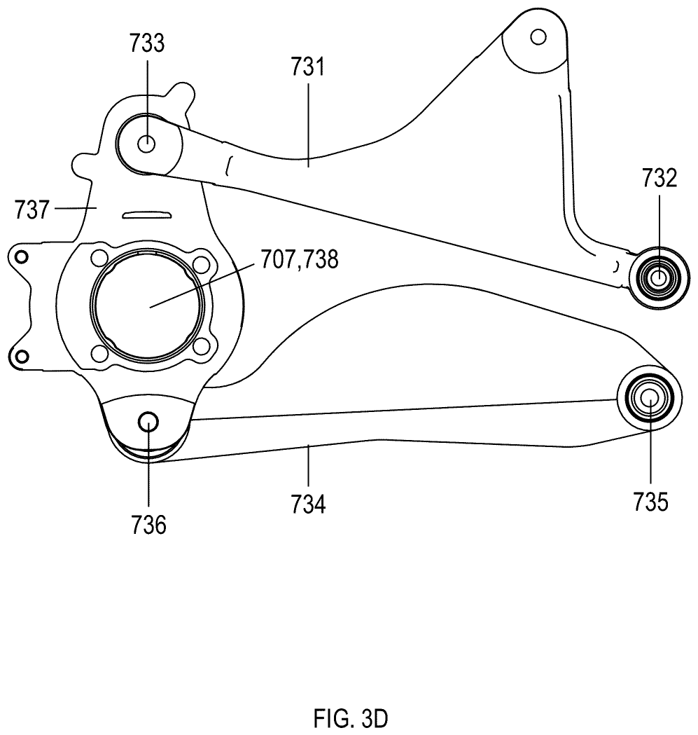

Referring to FIG. 3A, the upper 731 and lower 734 trailing links may take the form of a double-A arm configuration, shown as dashed lines. The upper A arm 731 is denoted by a dashed-dotted line and may comprise proximal pivot points 732 and a distal pivot point 733. The lower A arm 734 is denoted by a dashed line and may comprise proximal pivot points 735 and a distal pivot point 736. FIG. 3B shows the orientation of the dual trailing links 731, 734 in the plane of motion, which is coincident with the plane of the page. The proximal pivot points 732, 735 have a smaller distance between them than the distal pivot points 733, 736, thereby satisfying the requirement for forming an instantaneous center (IC) that is forward of the proximal pivot points 732, 735. The distal pivot points 733 and 736 may be coupled to the top and bottom, respectively, of an upright 737 with a knuckle 738 having an axis oriented perpendicular to the plane of motion of the trailing links 731, 734. The wheel 705 axis is coincident with the knuckle 738 axis. The distal pivot points 733, 736 may be positioned substantially vertically with respect to the axle of the wheel 705. Such an arrangement is important for maximizing the effective swingarm length, as discussed below.

Referring to FIGS. 3B-3D, features of the upper 731 and lower 734 trailing links and the upright 737 may be observed. For example, the upper 731 and lower 734 trailing links and the upright 737 may be purposed for ease of manufacturing, manifesting as particular shapes while, for instance, optimizing strength and weight characteristics. In one aspect, the upper 731 and lower 734 trailing links may include a “web”, i.e., the cross-sectional thickness throughout the central portions (which may or may not be variable) and one or more “flange” portions, i.e., the cross-sectional thickness throughout the peripheral portions (which may or may not be variable). Additionally, the upper 731 and lower 734 trailing links may take certain “profiles”, i.e., the outline(s) as provided in FIG. 3D, which may be purposed to contribute to strength and weight reduction characteristics. Other parameters that contribute to shapes may include lateral stability, feasibility of construction/manufacturability, assembly, adjustability, and monetary expense. The suspension system 700 contemplated herein may provide for adjustability to counteract the effects of tolerancing of the suspension system 700 with respect to the vehicle 100. For example, die-casting tolerances of parts, and adjustments of the suspension system 700 to accommodate manufacturing are considered within the scope of this disclosure.

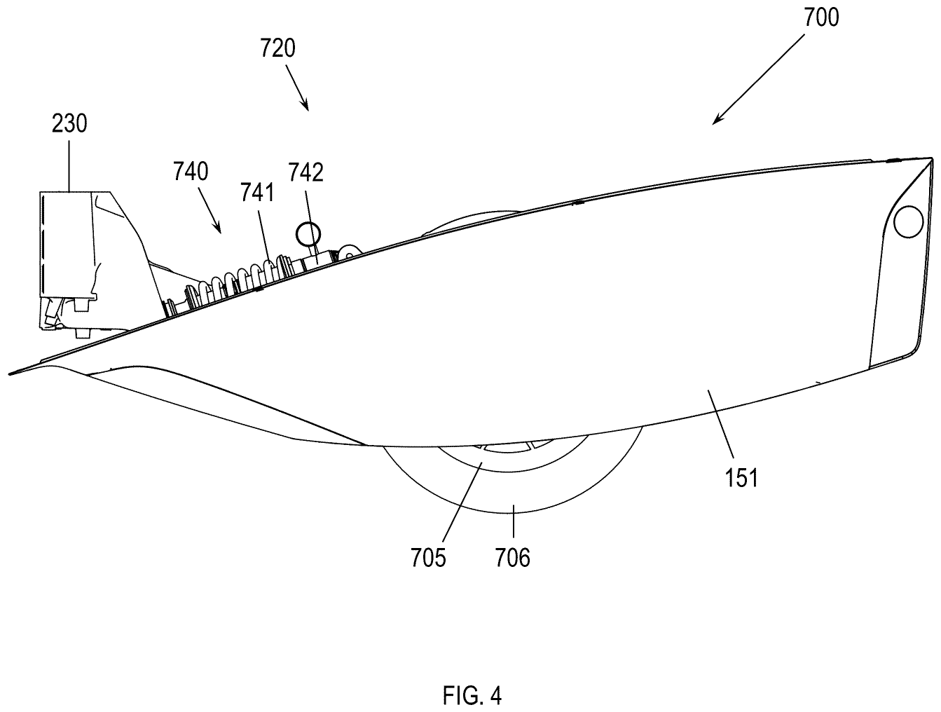

FIG. 4 illustrates the shape of the suspension system 700 with the enclosure 151 covering all but the lower portion of the wheel 705 and tire 706. The portions of the rear subframe 230 and rear suspension assembly 720, such as the spring/damper assembly 740 including the spring 741 and damper 742, that protrude above the enclosure 151 are preferably interior to the vehicle 100 when the enclosure 151 is assembled thereto.

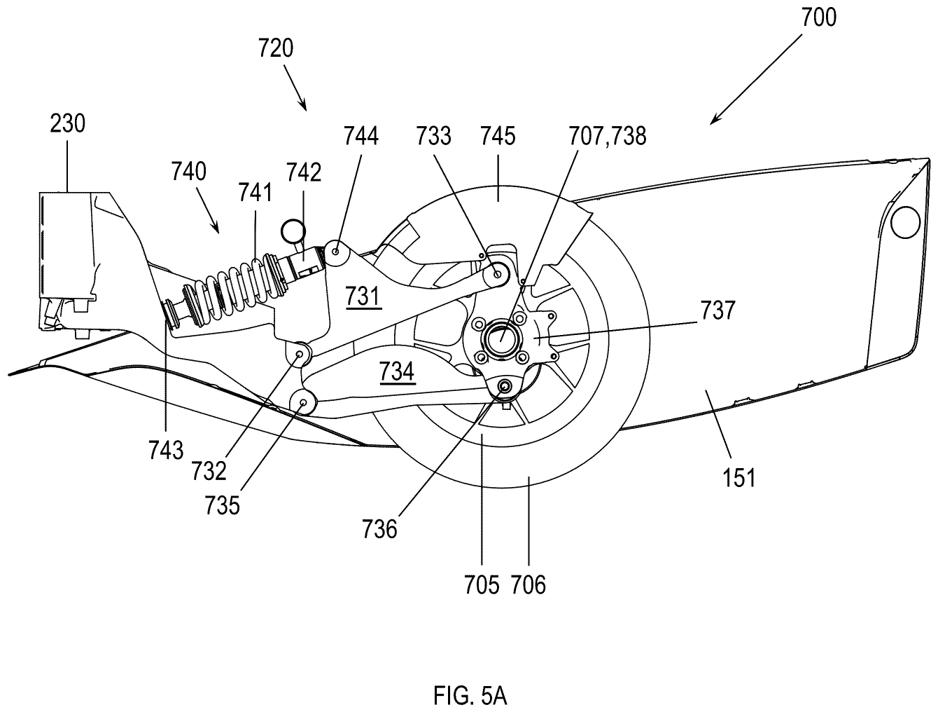

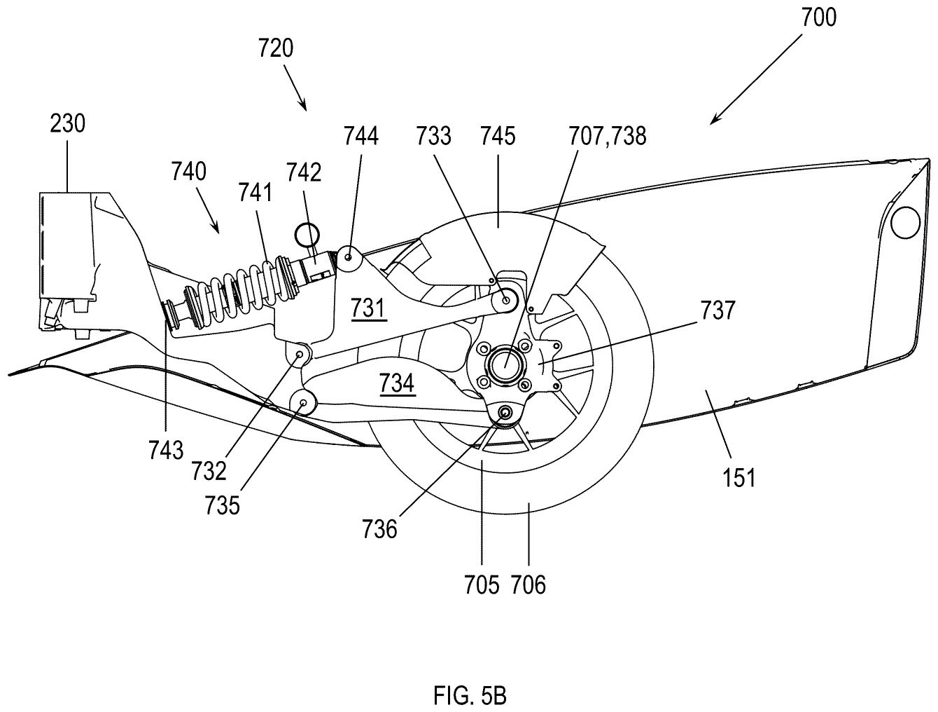

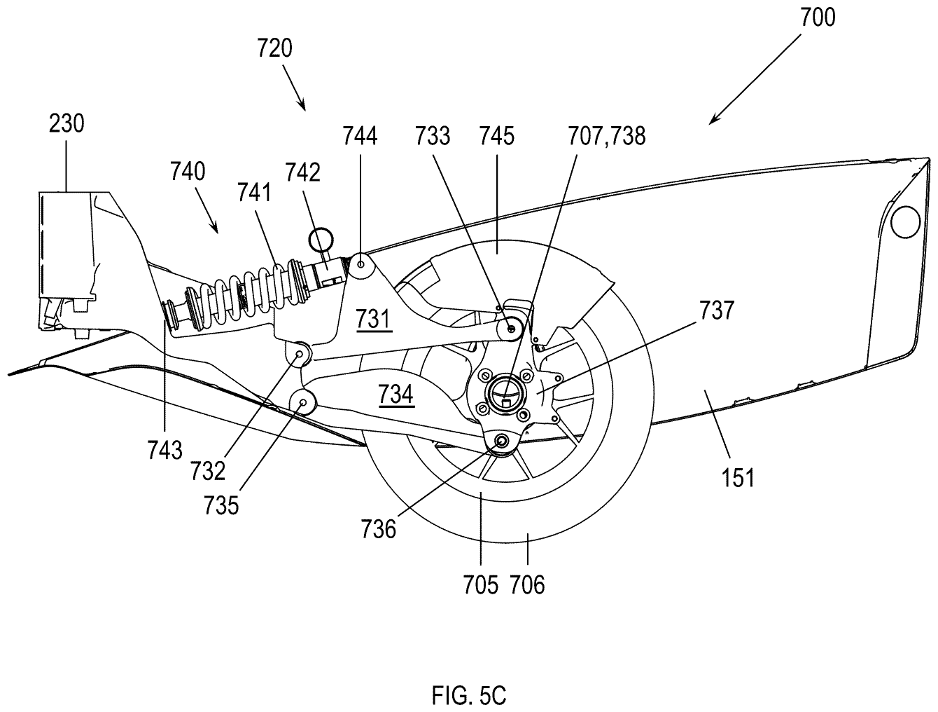

The motion of the rear suspension assembly 720 may be viewed through FIGS. 5A-C. In FIG. 5A, the wheel 705 and tire 706 are shown in a configuration corresponding to their maximum upward travel. The dual trailing links 731, 734 are coupled at proximal ends 732, 735 to the rear subframe 230 and at distal ends 733, 736 to the rear upright 737. The wheel axle 707 is mounted to and coincident with the knuckle 738. The spring/damper assembly 740 may be coupled at a proximal end 743 to the rear subframe 230 and at a distal end 744 to the lower trailing link 734. The spring/damper assembly 740 may be advantageously positioned in the orientation shown, for example, in FIG. 5A, where the proximal end 743 is vertically positioned lower than that of the distal end 744 forming a connection between the upper arm 731 pivot point 733 and the knuckle 738 as well as the pivot point 732 and a protrusion, post or otherwise an attachment point on the rear subframe 230. This arrangement of the spring/damper assembly 740 can provide for enhanced dampening characteristics. In FIG. 5B, the wheel 705 and tire 706 are shown in a configuration corresponding to their neutral position and the spring 741 has nominal compression. In FIG. 5C, the wheel 705 and tire 706 are shown in a configuration corresponding to their maximum downward travel and the spring 741 is uncompressed. The total vertical travel of the wheel in this embodiment may be approximately 100 mm. Alternatively, the total vertical travel of the wheel and/or suspension assembly may be greater or less than 100 mm, as appropriate for, e.g., variations in vehicle geometry, weight characteristics, and/or location of the center of gravity.

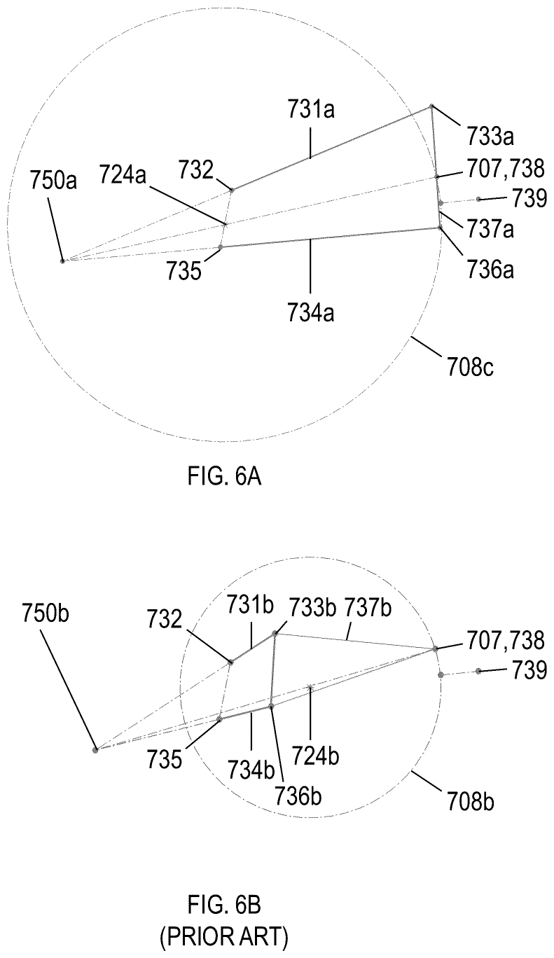

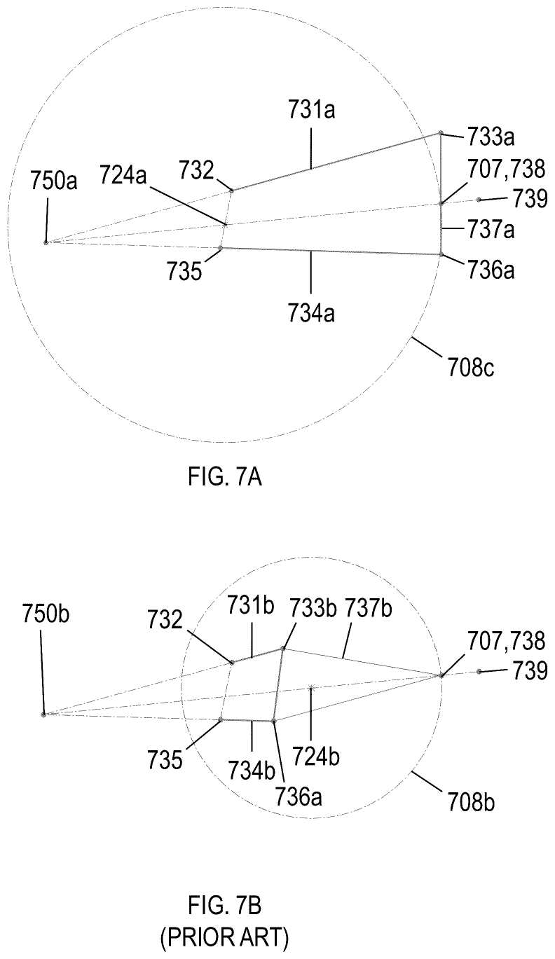

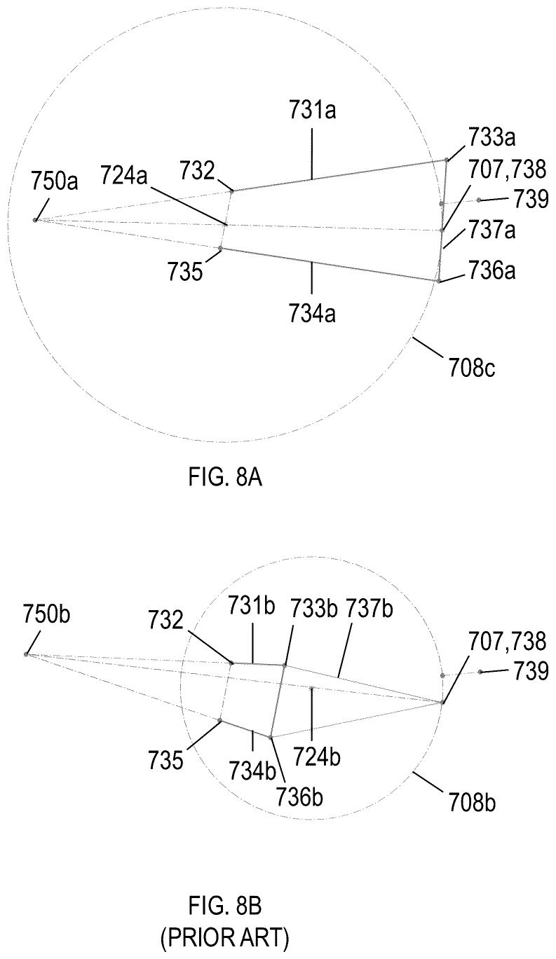

The relative advantage of the configuration of the present invention may be more easily understood through FIGS. 6A-8B illustrating a kinematic model showing the operation, or the dynamic motion, of the suspension system 700 shown in FIGS. 5A-5C. For example, FIG. 6A illustrates the geometry of the rear suspension system 700 in a maximum upward displacement state of the suspension system 700 of FIG. 5A, FIG. 7A illustrates a mid-point displacement or neutral state of the suspension system 700 in FIG. 5B, and FIG. 8A illustrates the maximum downward displacement of the suspension system 700 in FIG. 5C. Conversely, FIGS. 6B, 7B, and 8B, illustrate a kinematic model of conventional suspension systems and, when compared to the corresponding embodiments shown in FIGS. 6A, 7A, and 8A, the advantage of the present invention is clearly shown.

FIG. 6A illustrates, in accordance with the present invention, the kinematic arrangement corresponding to FIG. 5A using dual trailing links 731a, 734a that comprise proximal pivot points 732, 735 that are fixed relative to the chassis and distal pivot points 733a, 736a that rotate about the proximal ends 732, 735. The distal pivot points 733a, 736a are connected by an upright 737a with a knuckle 738 coincident with the wheel axle 707. A dashed line 739 represents the neutral point of the suspension system. The instantaneous center (IC) may be located by extending the axes of the upper 731a and lower 734a trailing links and finding their intersection 750a. This arrangement may be compared with a conventional, dual trailing link configuration according to FIG. 6B, also shown in its maximum upward displacement state. In this approach, trailing links 731b, 734b comprise proximal pivot points 732, 735 that are fixed relative to the chassis and distal pivot points 733b, 736b that rotate about the proximal ends 732, 735. The distal pivot points 733b, 736b are connected to a bracket 737b that extends the remaining distance to the wheel axle 707 and is attached thereto by a knuckle 738. A dashed line 739 represents the neutral point of the suspension system. In a similar way, the IC of this configuration may be located by extending the axes of the upper 731b and lower 734b trailing links and finding their intersection 750b.

In FIG. 7A the geometry of the rear suspension systems is exhibited in a neutral state corresponding to the embodiment shown in FIG. 5B, while FIG. 7B illustrates a corresponding conventional configuration. FIG. 8A shows the geometry of the rear suspension systems in a maximum downward displacement state corresponding to the geometry shown in FIG. 5C, while FIG. 8B illustrates a corresponding conventional configuration.

In FIGS. 6A through 8B, the mechanics of the various rear suspension geometries is shown. Note that, in the configurations of FIGS. 6A through 8B, the proximal pivot points 732, 735 and their distances from the axle/knuckle 707, 738 are identical, while the trailing link angles produce identical ICs 750a, 750b in a neutral state. In this way, the aspects of the present invention to conventional suspensions may be accurately compared as between these configurations. In a first aspect, the ICs 750a, 750b move in seesaw (counteracting) fashion relative to the axle/knuckle 707, 738 and should therefore not be construed as the pivot point for the axle/knuckle 707, 738. Instead, the virtual pivot point (VPP) of the axle 707 corresponds to the fulcrum 724a, 724b of the seesaw, which is significantly different between the present invention and a conventional suspension.

In the case of the present invention of FIGS. 6A, 7A & 8A, the VPP/fulcrum 724a is approximately midway between the proximal ends 732, 735 of the upper and lower trailing links 731a, 734b. In the case of the conventional geometry (dual trailing links with extending bracket) of FIGS. 6B, 7B & 8B, the VPP/fulcrum 724b is almost midway between the proximal ends 732, 735 of the upper and lower trailing links 731b, 734b and the axle/knuckle 707, 738. The distance between the VPP 724a, 724b and the axle/knuckle 707, 738 is the effective swingarm length and is equal to the radius of the circle 708b, 708c describing the motion of the axle/knuckle 707, 738. In the case of the present invention, the effective swingarm length is maximized by making the distal pivot points 733a, 736a colinear, and, in this case, substantially vertically oriented with the axle/knuckle 707, 738. In the case of the conventional geometry, the effective swingarm length is considerably shortened relative to the present invention. Thus, the circle of motion 708c induced by the geometry of the present invention is much larger than the circle of motion 708b induced by the conventional geometry. This results in a more vertical motion of the axle/knuckle 707, 738 under road induced deflection and a more comfortable ride for the vehicle occupants.

A rear wheel vehicle suspension system 700 has been described with embodiments corresponding to dual trailing links 720, wherein an effective swingarm length can be maximized for vertical shock absorption by making the distal pivot points substantially colinear with axle/knuckle. The orientation of the line connecting the distal pivot points with the axle/knuckle need not be vertical in order to maximize the effective swingarm length; only deviations from collinearity will reduce the effective swingarm length. The present disclosure. in one aspect, makes maximum use of the space allotted for the rear suspension system-that is, the embodiment contemplated herein provides the greatest effective swingarm length for a given distance between the vehicle chassis and the wheel. This arrangement is therefore advantageous for certain vehicle designs, such as in an aerodynamic vehicle where the rear suspension is surrounded by an aerodynamic cowling which severely limits the available space. Applications for concepts according to the present invention are, however, not limited thereto, and may be applicable to the rear suspension of, for example, four-wheeled or two-wheeled vehicles, vehicles having geometric limitations dictated by design constraints other than aerodynamic considerations, and/or vehicles having alternative lift and squat characteristics, as the design may require.

Referring to FIG. 9, certain characteristics of the suspension system 700 may be observed. The upper 731 and lower 734 link lines, based upon the location of the proximal pivot point 732 and the distal pivot point 733, and the proximal pivot point 735 and a distal pivot point 736, may diverge from the upper and lower proximal ends 732, 753, to the upper and lower distal ends 733, 736, to define an instantaneous center 750. Upon the driver of the vehicle depressing the acceleration pedal, thereby causing the motor to advance the vehicle 100 forward, a reaction force 751 then occurs in the direction shown as the line passing through the tire 706 patch 709 (contact point with the road) and the instantaneous center 750. The vehicle 100 comprises a center of gravity, generically shown in FIG. 9 as element CG. The perpendicular line drawn from the reaction force 751 through CG defines the moment arm delta “d” as shown. The system advantageously provides for desirable lift and squat characteristics based upon the moment arm delta “d” selected according to the present invention.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rear suspension assembly comprising:
an upright including an upper upright end, a lower upright end, and a knuckle disposed therebetween the knuckle being adapted for operably coupling to a wheel characterized by an axis of rotation;
an upper link including an upper link line characterized by an upper proximal end and an upper distal end, the upper proximal end being adapted for rotatable coupling to a support frame, and the upper distal end being rotatably coupled to the upright at the upper upright end;
a lower link including a lower link line characterized by a lower proximal end and a lower distal end, the lower proximal end being adapted for rotatable coupling to said support frame, and the lower distal end being rotatably coupled to the upright at the lower upright end; and
a spring/mass damper assembly having a proximal damper end and a distal damper end, the proximal damper end being adapted for rotatable coupling to said support frame at a point about the level of the axis of rotation, the distal damper end rotatably connected to said upper link at a point above the connection of said proximal damper end to said support frame.

2. A rear suspension comprising:
the rear suspension assembly according to claim 1; and
an enclosure that at least partially surrounds the rear suspension assembly.

3. The rear suspension according to claim 2, wherein the enclosure is at least partially characterized by one or more zero-camber, NACA airfoil profiles.

4. The rear suspension according to claim 3, wherein the upper and lower link lines diverge from the upper and lower proximal ends to the upper and lower distal ends to define an instantaneous center.

5. The rear suspension according to claim 4, wherein the enclosure at least partially surrounds the rear suspension assembly characterized in part by being disposed between the instantaneous center and the upper and lower links.

6. The rear suspension according to claim 5, wherein the upper and lower link lines diverge from the upper and lower proximal ends to the upper and lower to define an instantaneous center.

7. A rear suspension assembly comprising:
an upright including an upper upright end, a lower upright end, and a knuckle disposed therebetween the knuckle being adapted for operably coupling to a wheel characterized by an axis of rotation;
an upper link including an upper link line characterized by an upper proximal end and an upper distal end, the upper proximal end being adapted for rotatable coupling to a support frame, and the upper distal end being rotatably coupled to the upright at the upper upright end;
a lower link including a lower link line characterized by a lower proximal end and a lower distal end, the lower proximal end being adapted for rotatable coupling to said support frame, and the lower distal end being rotatably coupled to the upright at the lower upright end; and
an enclosure that at least partially surrounds the rear suspension assembly,
wherein the upper and lower link lines diverge from the upper and lower proximal ends to the upper and lower distal ends to define an instantaneous center,
and wherein at least a portion of the enclosure is disposed between the instantaneous center and the upper and lower links.

8. The rear suspension assembly according to claim 7, further comprising a spring/mass damper assembly having a proximal damper end and a distal damper end, the proximal damper end being adapted for rotatable coupling to said support frame at a point about the level of the axis of rotation, the distal damper end rotatably connected to said upper link at a point above the connection of said proximal damper end to said support frame.

9. The rear suspension assembly according to claim 8, wherein the enclosure is at least partially characterized by one or more zero-camber, NACA airfoil profiles.
